(19) United States
(12) Patent Application Publication
(10) Pub. No.: US 2025/0367765 A1
(43) Pub. Date: Dec. 4, 2025

(54) LASER MACHINING HEAD AND LASER MACHINING SYSTEM

(71) Applicant: Fanuc Corporation, Minamitsuru-gun, Yamanashi (JP)

(72) Inventor: Takashi IZUMI, Minamitsuru-gun, Yamanashi (JP)

(73) Assignee: Fanuc Corporation, Minamitsuru-gun, Yamanashi (JP)

(21) Appl. No.: 18/876,852

(22) PCT Filed: Jul. 4, 2022
(86) PCT No.: PCT/JP2022/026614

§ 371 Date: Dec. 19, 2024

(51) Int. Cl. B23K 26/38; B23K 26/08

(52) U.S. Cl. CPC B23K 26/38; B23K 26/0876

(57) ABSTRACT

Provided is a laser machining head with which a laser emission operation can be performed in a manual operation mode in which a control device executes the laser emission operation in accordance with a manual laser emission command, and in an automatic operation mode in which the control device automatically executes the laser emission operation in accordance with a machining program. The laser machining head includes: a first input device that receives an input operation for sending the manual laser emission command to the control device; and a distance measurement sensor that measures a distance between the laser machining head and a workpiece W when the control device executes the laser emission operation in the automatic operation mode.

### CROSS REFERENCE TO RELATED APPLICATIONS

This is the U.S. National Phase application of PCT/JP2022/026614, filed Jul. 4, 2022, the disclosure of this application being incorporated herein by reference in its entirety for all purposes.

### FIELD OF THE INVENTION

The present disclosure relates to a laser processing head and a laser processing system.

### BACKGROUND OF THE INVENTION

A laser processing head applied to a laser processing system that automatically performs a laser emission operation in accordance with a machining program is known (Patent Literature 1). On the other hand, a laser processing head manually operated by an operator is also known (Patent Literature 2).

### PATENT LITERATURE

PTL 1: JP 2000-52076 A

PTL 2: JP 2000-24787 A

### SUMMARY OF THE INVENTION

A cooperative robot capable of executing work in cooperation with an operator has been widely used. Accordingly, there is a demand for a laser processing head applicable to a manual drive mode, in which an operator manually performs a laser emission operation and an automatic drive mode, in which a laser processing system automatically performs a laser emission operation.

In one aspect of the present disclosure, a laser processing head capable of performing a laser emission operation in a manual drive mode, in which a controller executes a laser emission operation in accordance with a manual laser emission command and an automatic drive mode, in which the controller automatically executes a laser emission operation in accordance with a machining program includes: a first input device that receives an input operation to transmit the manual laser emission command to the controller; and a distance measuring sensor that measures a distance between the laser processing head and a workpiece when the controller executes the laser emission operation in the automatic drive mode.

### BRIEF DESCRIPTION OF THE DRAWINGS

FIG. 1 is a schematic diagram of a laser processing system according to one embodiment.

FIG. 2 is a block diagram of the laser processing system illustrated in FIG. 1.

FIG. 3 is an enlarged view of a mode selection switch illustrated in FIG. 1.

FIG. 4 is an enlarged view of a laser processing head illustrated in FIG. 1.

FIG. 5 illustrates a first input device according to another embodiment.

FIG. 6 is an enlarged view of a laser processing head according to another embodiment.

FIG. 7 is a block diagram of the laser processing head illustrated in FIG. 6.

FIG. 8 is a diagram for explaining a function of a contact detection device illustrated in FIG. 6.

FIG. 9 is a diagram for explaining a function of a command cutoff unit illustrated in FIG. 6, and illustrates a state in which the command cutoff unit cuts off a manual laser emission command.

FIG. 10 is a diagram for explaining a function of a command cutoff unit illustrated in FIG. 6, and illustrates a state in which the command cutoff unit permits transmission of a manual laser emission command.

FIG. 11 is a flowchart showing an example of an operation flow of the laser processing head illustrated in FIG. 6.

FIG. 12 is a flowchart showing an example of a flow of step S2 in FIG. 11.

FIG. 13 is a flowchart showing an example of a flow of step S3 in FIG. 11.

FIG. 14 is a block diagram of a laser processing head according to still another embodiment.

FIG. 15 is a flowchart showing an example of the flow of step S2 executed by the laser processing head illustrated in FIG. 14.

### DETAILED DESCRIPTION OF EMBODIMENTS OF THE INVENTION

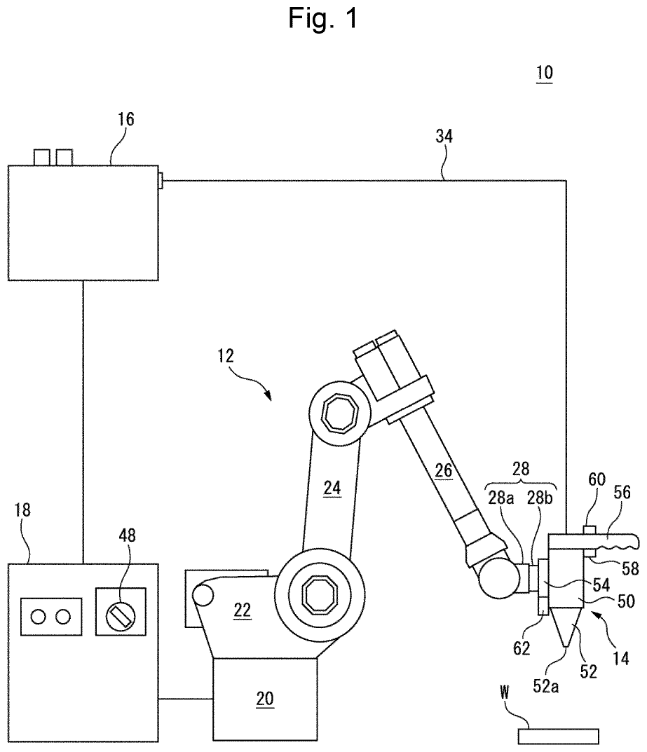

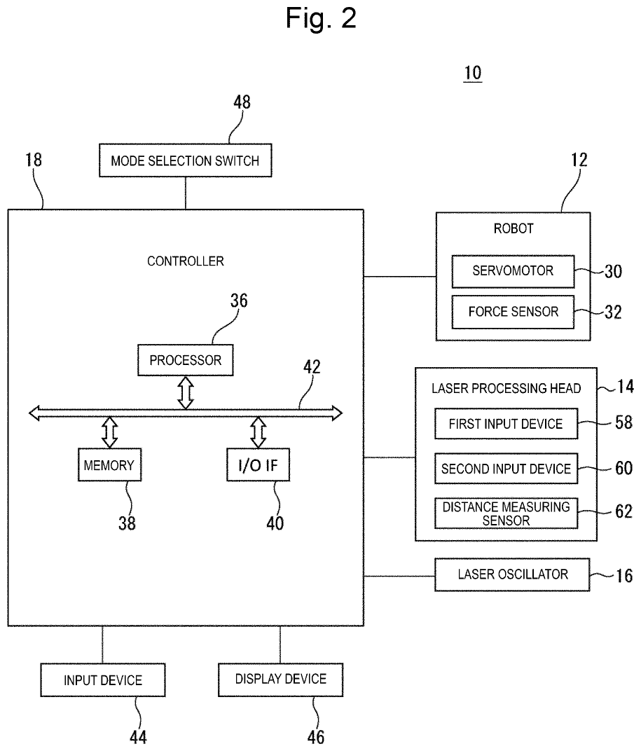

Embodiments of the present disclosure are described in detail below with reference to the drawings. Note that in various embodiments described below, the same elements are denoted with the same reference signs, and overlapping description is omitted. First, a laser processing system 10 according to one embodiment will be described with reference to FIG. 1 and FIG. 2. The laser processing system 10 is a system that can execute laser process (laser welding, laser cutting, and the like) on a workpiece W in cooperation with an operator.

Specifically, the laser processing system 10 includes a robot 12, a laser processing head 14, a laser oscillator 16, and a controller 18. The robot 12 moves the laser processing head 14 relative to the workpiece W. In the present embodiment, the robot 12 is a vertical articulated robot and includes a robot base 20, a swivel body 22, a lower arm 24, an upper arm 26, and a wrist 28.

The robot base 20 is fixed on a floor of a work cell. The swivel body 22 is provided at the robot base 20 so as to be capable of swiveling about a vertical axis. The lower arm 24 is provided at the swivel body 22 rotatably about a horizontal axis. The upper arm 26 is provided rotatably at a tip end part of the lower arm 24. The wrist 28 includes a wrist base 28a provided at a tip end part of the upper arm 26 rotatably about two axes orthogonal to each other, and a wrist flange 28b provided rotatably at the wrist base 28a.

The components of the robot 12 (the robot base 20, the swivel body 22, the lower arm 24, the upper arm 26, and the wrist 28) are respectively provided with a plurality of servomotors 30 (FIG. 2). These servomotors 30 cause each of the movable components (i.e., the swivel body 22, the lower arm 24, the upper arm 26, the wrist 28, and the wrist flange 28b) of the robot 12 to rotate about a drive axis in response to a command from the controller 18. Due to this, the robot 12 moves at the laser processing head 14.

The robot 12 is provided with a force sensor 32. The force sensor 32 detects an external force F applied to the robot 12. As an example, the force sensor 32 includes a torque sensor that is provided in each of the servomotors 30 of the robot 12 and detects torque applied to an output shaft of the servomotor 30.

As another example, the force sensor 32 is provided in a component (e.g., the robot base 20 or the wrist 28) of the robot 12 and includes a six-axis force sensor capable of detecting forces in the six-axis directions. Based on detection data of the force sensor 32, the controller 18 can specify the magnitude and direction of the external force F applied to the robot and the part (e.g., the wrist 28) of the robot 12 applied with the external force F.

The laser oscillator 16 internally performs laser oscillation in response to a command (such as a laser power command) from the controller 18 to generate a laser beam LB. The laser oscillator 16 may be of any type such as a fiber laser oscillator, a pulse laser oscillator, a CO2 laser oscillator, or a solid-state laser (YAG laser) oscillator. The laser oscillator 16 supplies the generated laser beam LB to the laser processing head 14 via a light guide path 34. The light guide path 34 can be configured by an optical fiber, a cavity, a light guide material such as crystal, a reflecting mirror, an optical lens, or the like.

The controller 18 controls a laser emission operation LO of operating the laser oscillator 16 to emit the laser beam LB from the laser processing head 14, and a movement operation MO of operating the robot 12 to cause the laser processing head 14 attached to the robot 12 to move with respect to the workpiece W. Specifically, as illustrated in FIG. 2, the controller 18 is a computer including a processor 36, a memory 38, and an I/O interface 40.

The processor 36 includes a CPU or a GPU, is communicably connected to the memory 38 and the I/O interface 40 via a bus 42, and performs various arithmetic processing to execute laser process described later while communicating with these components. The memory 38 includes a RAM or a ROM, and temporarily or permanently stores various data used in arithmetic processing executed by the processor 36 and various data generated in the middle of the arithmetic processing.

The I/O interface 40 includes, for example, an Ethernet (registered trademark) port, a USB port, an optical fiber connector, or an HDMI (registered trademark) terminal, and communicates data with an external device in a wired or wireless manner under a command from the processor 36. The robot 12 (specifically, the servomotor 30 and the force sensor 32), the laser processing head 14, and the laser oscillator 16 are communicatively connected to the I/O interface 40.

The controller 18 is further provided with an input device 44 and a display device 46. The input device 44 includes a keyboard, a mouse, or a touchscreen, and receives an input of data from an operator. The display device 46 includes a liquid crystal display or an organic EL display, and displays various data.

The input device 44 and the display device 46 are communicatively connected to the I/O interface 40 in a wired or wireless manner. Note that the input device 44 and the display device 46 may be integrated into the housing of the controller 18, or may be provided as, for example, one computer (PC or the like) separately from the housing of the controller 18.

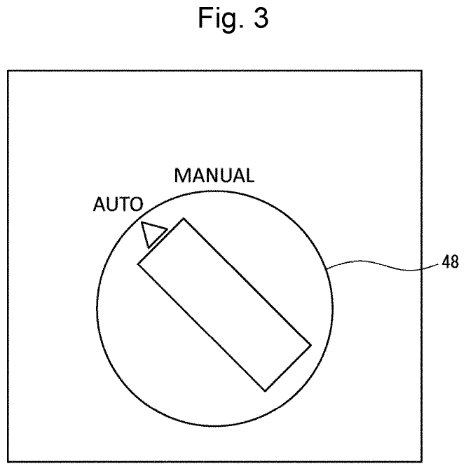

In the present embodiment, the controller 18 is provided with a mode selection switch 48. The mode selection switch 48 is for selecting a drive mode DM for the laser process executed by the controller 18. As illustrated in FIG. 3, in the present embodiment, the mode selection switch 48 is configured to be switchable with the drive mode DM between a manual drive mode DM1 represented as “MANUAL” and an automatic drive mode DM2 represented as “AUTO”.

The operator can switch the drive mode DM between the manual drive mode DM1 and the automatic drive mode DM2 by operating the mode selection switch 48. The manual drive mode DM1 is the drive mode DM in which the operator grips and carries the laser processing head 14 by hand, causes the controller 18 to manually execute the laser emission operation LO, and manually performs laser process on the workpiece W with the laser beam LB emitted from the laser processing head 14. In this manual drive mode DM1, the operator manually gives a manual laser emission command CM1 described later to the controller 18, and the processor 36 of the controller 18 executes the laser emission operation LO in response to the manual laser emission command CM1.

On the other hand, the automatic drive mode DM2 is a drive mode DM in which the processor 36 of the controller 18 automatically executes the laser emission operation LO and the movement operation MO in accordance with the machining program PG1 created in advance. Specifically, the processor 36 sequentially generates commands to the laser oscillator 16 in accordance with the machining program PG1, operates the laser oscillator 16 in accordance with the commands, and automatically executes the laser emission operation LO to emit the laser beam LB from the laser processing head 14.

The processor 36 sequentially generates commands (position command, speed command, torque command, and the like) to the robot 12 (specifically, each servomotor 30) in accordance with the machining program PG1, operates the robot 12 in accordance with the commands, and automatically executes the movement operation MO to move the laser processing head 14 with respect to the workpiece W. This machining program PG1 is created by the operator and stored in the memory 38 in advance. FIG. 3 illustrates a state in which the automatic drive mode DM2 (“AUTO”) is selected by the mode selection switch 48.

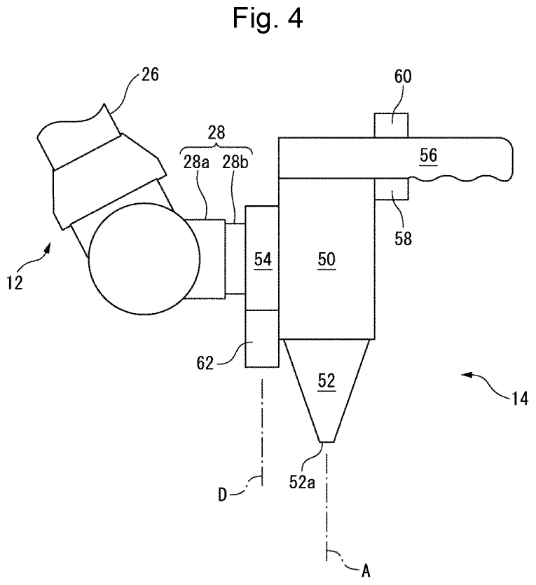

The laser processing head 14 is detachably attached to the wrist flange 28b of the robot 12. Specifically, as illustrated in FIG. 4, the laser processing head 14 includes a head body 50, a nozzle 52, an attachment tool 54, a grip 56, a first input device 58, a second input device 60, and a distance measuring sensor 62. The head body 50 is hollow and internally houses optical components such as an optical lens (collimator lens, focus lens, and the like) and a lens drive unit (e.g., a servomotor) that displaces the optical lens in response to a command from the controller 18.

The nozzle 52 is hollow and is provided at the tip end part of the head body 50. In the present embodiment, the nozzle 52 has an outer shape having a truncated conical shape in which the cross-sectional area decreases from the base end part toward the tip end part, and an emission port 52a is formed at the tip end part. A cavity chamber is formed inside the nozzle 52 and the head body 50, and an assist gas AG is supplied into the chamber from an externally provided assist gas supply device (not illustrated). The laser beam LB generated by the laser oscillator 16 propagates in the chamber and is emitted from the emission port 52a along an optical axis A together with the assist gas AG.

The attachment tool 54 is provided on the head body 50, and is detachably attached to the wrist flange 28b of the robot 12. As an example, the attachment tool 54 may include a fastener such as a bolt and may be fastened to the wrist flange 28b by the fastener. As another example, the attachment tool 54 may include an engagement part detachably engaged with an engaged part formed on the wrist flange 28b, and may be attached to or detached from the wrist flange 28b by engagement between the engaged part and the engagement part. As still another example, the attachment tool 54 may include an electromagnet, and may be adsorbed and fixed to the wrist flange 28b by an electromagnetic force generated by the electromagnet. The laser processing head 14 is detachably attached to the wrist flange 28b of the robot 12 via the attachment tool 54.

The grip 56 is provided at a base end part of the head body 50 so as to be capable of be gripped with one hand by the operator. The grip 56 may have an uneven part corresponding to a finger of one hand for easy grip with the one hand by the operator. By gripping the grip 56 and removing the laser processing head 14 from the wrist flange 28b, the operator can carry the laser processing head 14.

The first input device 58 receives an input operation to transmit the manual laser emission command CM1 to the controller 18. In the present embodiment, the first input device 58 includes a press button, a switch, or a touchscreen with which an operator can perform an input operation with a hand, and is provided at the laser processing head 14 (e.g., the head body 50 or the grip 56).

Upon receiving an input operation (e.g., pressing of the press button by hand, switching of the switch, or a touch operation on the touchscreen) by the operator, the first input device 58 supplies the manual laser emission command CM1 to the controller 18. The manual laser emission command CM1 may be an ON signal (or “1” signal).

Upon receiving the manual laser emission command CM1 during execution of the manual drive mode DM1, the controller 18 executes the laser emission operation LO in response to the manual laser emission command CM1. In this way, as the manual drive mode DM1, the operator can manually perform the laser process on the workpiece W by the laser beam LB emitted from the emission port 52a of the laser processing head 14 along the optical axis A while carrying the laser processing head 14 with hand. In the present embodiment, the first input device 58 is provided adjacent to the grip 56 so that the operator can perform input operation with one hand gripping the grip 56.

The second input device 60 receives an input operation to transmit a manual gas emission command CM2 to emit the assist gas AG. Specifically, the second input device 60 includes a press button, a switch, or a touchscreen with which the operator can perform an input operation with a hand, and upon receiving an input operation by the operator, transmits the manual gas emission command CM2 to the controller 18. The manual gas emission command CM1 may be an ON signal (or “1” signal).

Upon receiving the manual gas emission command CM2 during execution of the manual drive mode DM1, the controller 18 operates the assist gas supply device to cause the assist gas supply device to supply the assist gas AG to the laser processing head 14. Due to this, the assist gas AG is emitted together with the laser beam LB from the emission port 52a of the laser processing head 14 gripped with a hand by the operator.

The second input device 60 may be configured to directly transmit the manual gas emission command CM1 to the assist gas supply device. In the present embodiment, similarly to the above-described first input device 58, the second input device 60 is also provided adjacent to the grip 56 and the first input device 58 so that the operator can perform input operation with one hand gripping the grip 56.

The distance measuring sensor 62 measures a distance d between the laser processing head 14 (e.g., emission port 52a) and the workpiece W when the controller 18 executes the laser emission operation LO in the automatic drive mode DM2. Specifically, the distance measuring sensor 62 is, for example, a capacitance type, an infrared type, a laser type, or a sound wave type (e.g., an ultrasonic type) distance measuring sensor.

For example, in the case of the capacitance type, the distance measuring sensor 62 is provided in the head body 50 (or the nozzle 52) so as to measure a distance to an object present at a position closest to the laser processing head 14. On the other hand, in the case of the infrared type, the laser type, or the sound wave type, the distance measuring sensor 62 is attached to the head body 50 (or the nozzle 52) such that a measurement direction D (in other words, the radiation direction of the infrared ray, the laser, or the sound wave) in which the distance to the object is measured is parallel to the optical axis A. That is, in this case, the distance measuring sensor 62 measures the distance d between the laser processing head 14 (emission port 52a) and the workpiece W in the direction of the optical axis A.

The distance measuring sensor 62 continuously (e.g., periodically) measures the distance d when the controller 18 executes the laser emission operation LO in the automatic drive mode DM2. In the automatic drive mode DM2, the processor 36 of the controller 18 executes the laser emission operation LO when the distance d measured by the distance measuring sensor 62 is within a predetermined allowable range RG, and does not execute the laser emission operation LO when the distance d is out of the allowable range RG.

The processor 36 stops the operation of the robot 12 when the external force F detected by the force sensor 32 exceeds a predetermined threshold Fₜₕ when executing the movement operation MO in the automatic drive mode DM2. This can urgently stop the robot 12, when the robot 12 in the movement operation MO collides with a surrounding object (e.g., the operator).

As described above, in the present embodiment, the laser processing head 14 is configured to be capable of a laser emission operation in the manual drive mode DM1 in which the controller 18 executes the laser emission operation LO in accordance with the manual laser emission command CM1 and the automatic drive mode DM2 in which the controller 18 automatically executes the laser emission operation LO in accordance with the machining program PG1.

In order to be applicable to both the manual drive mode DM1 and the automatic drive mode DM2 as described above, the laser processing head 14 includes the first input device 58 that receives an input operation to transmit the manual laser emission command CM1 to the controller 18, and the distance measuring sensor 62 that measures the distance d between the laser processing head 14 and the workpiece W when the controller 18 executes the laser emission operation LO in the automatic drive mode DM2.

According to this configuration, the operator can execute the laser process while freely switching between the manual drive mode DM1 and the automatic drive mode DM2 in response to the progress of the laser process. Due to this, various laser processes can be executed. In the manual drive mode DM1, by operating the first input device 58, the operator can manually control the laser emission operation LO, and on the other hand, in the automatic drive mode DM2, the controller 18 can automatically control the laser emission operation LO based on the distance d measured by the distance measuring sensor 62. Therefore, the safety of the work of laser process can be secured.

In the present embodiment, the first input device 58 includes a press button, a switch, or a touchscreen with which the operator can perform an input operation with a hand. According to this configuration, the operator can transmit the manual laser emission command CM1 to the controller 18 with a simple operation in the manual drive mode DM1.

In the present embodiment, the laser processing head 14 further includes the second input device 60 that receives an input operation to transmit the manual gas emission command CM2 to emit the assist gas AG. According to this configuration, the operator can also manually control the emission of the assist gas AG in the manual drive mode DM1.

In the present embodiment, the laser processing head 14 further includes the attachment tool 54 detachably attached to the robot 12 (specifically, the wrist flange 28b) that moves at the laser processing head 14, and the grip 56 that can be gripped with one hand by the operator. Then, the first input device 58 is provided adjacent to the grip 56 such that the one hand gripping the grip 56 can perform the input operation.

According to this configuration, the operator can easily execute the laser emission operation LO in the manual drive mode DM1 by operating the attachment tool 54 to remove the laser processing head 14 from the robot 12 in a state of gripping the grip 56 with one hand and operating the first input device 58 with the one hand.

On the other hand, the operator can easily execute the laser emission operation LO in the automatic drive mode DM2 by attaching the laser processing head 14 to the robot 12 via the attachment tool 54. This enables the operator to more smoothly and easily switch between the manual drive mode DM1 and the automatic drive mode DM2.

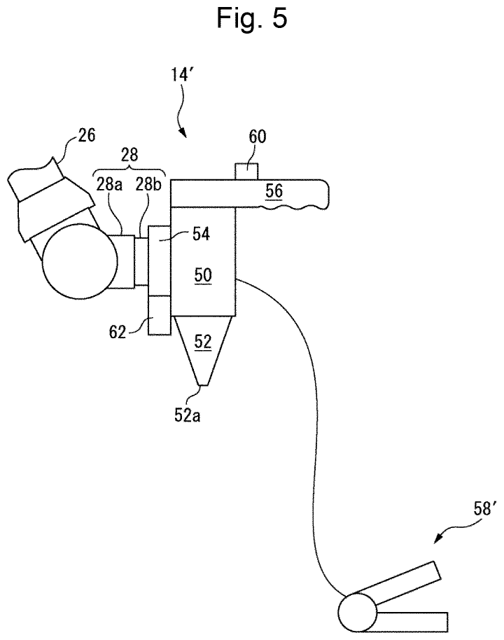

Note that the first input device 58 is not limited to a press button, a switch, or a touchscreen, and may have a foot pedal or a foot switch with which an operator can perform an input operation with a foot. Such a configuration is illustrated in FIG. 5. In a laser processing head 14′ illustrated in FIG. 5, a first input device 58′ includes a foot pedal or a foot switch, and is provided separately from the head body 50.

The first input device 58′ is electrically connected to an electronic component (e.g., a processor described below) housed inside the head body 50. Upon receiving an input operation (e.g., stepping on the foot pedal by a foot or switching of the foot switch) by the operator, the first input device 58′ transmits the manual laser emission command CM1 to the controller 18 via the electronic component in the head body 50.

Note that the first input devices 58 and 58′ are not limited to a press button, a switch, a touchscreen, a foot pedal, or a foot switch, and may be any type of input device. For example, the first input devices 58 and 58′ may have a microphone that detects the operator's voice and a voice analysis unit that analyzes the voice. In this case, the first input devices 58 and 58′ receive a voice input operation by the operator and transmit the manual laser emission command CM1 to the controller 18.

The second input device 60 may be omitted from the laser processing head 14 or 14′. In this case, the second input device 60 may be provided at the controller 18. Alternatively, the above-described input device 44 may function as the second input device 60. In this case, by operating the input device 44, the operator may operate the assist gas supply device to supply the assist gas AG to the laser processing head 14 or 14′.

The above-described grip 56 may be omitted, and the operator may grip the head body 50, for example, and carry the laser processing head 14 or 14′. The first input device 58 may be provided at any position of the laser processing head 14 or 14′, and the grip 56 and the first input device 58 may be disposed such that the operator can grip the grip 56 (or the head body 50) with one hand and operate the first input device 58 with the other hand.

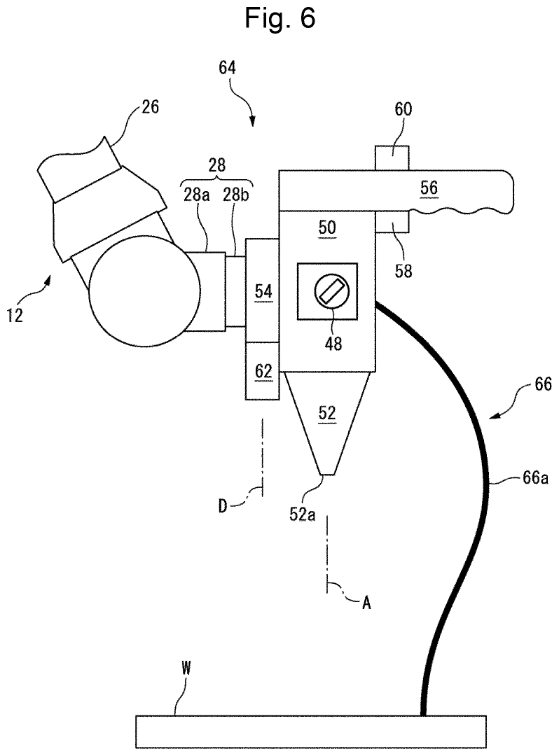

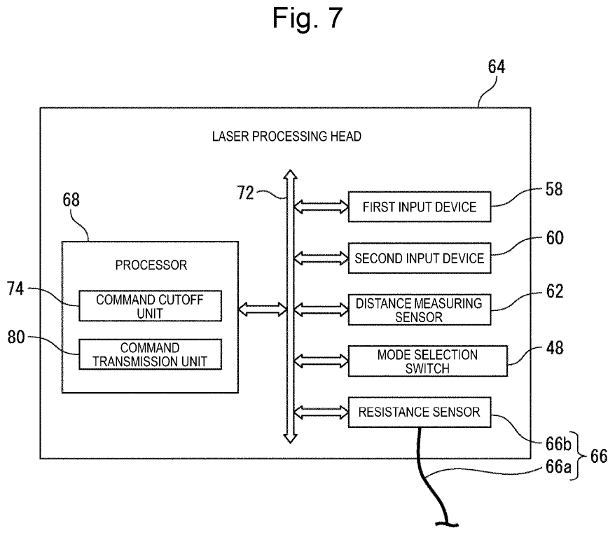

Next, a laser processing head 64 according to another embodiment will be described with reference to FIGS. 6 and 7. The laser processing head 64 is applicable to the laser processing system 10 in place of the laser processing head 14 described above and may be detachably attached to the wrist flange 28b of the robot 12. The laser processing head 64 is different from the above-described laser processing head 14 in the following configuration.

Specifically, the laser processing head 64 further includes the mode selection switch 48, a contact detection device 66, and a processor 68. In the present embodiment, the mode selection switch 48 is provided integrally with the head body 50, and can be switched between the manual drive mode DM1 and the automatic drive mode DM2 similarly to the above-described embodiment.

The contact detection device 66 detects whether or not the laser processing head 64 and the workpiece W are in contact or in non-contact. Specifically, the contact detection device 66 includes a conductive cable 66a and a resistance sensor 66b (FIG. 7). The conductive cable 66a has one end electrically connected to the head body 50 of the laser processing head 64, and the other end electrically connected to the workpiece W, thereby electrically connecting the laser processing head 64 and the workpiece W.

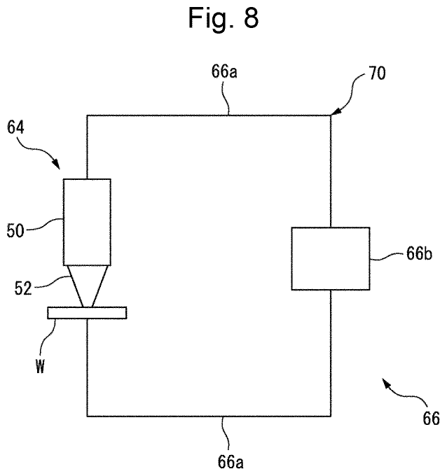

Here, in the present embodiment, at least a part of the head body 50 and the nozzle 52 of the laser processing head 64 is made of a conductive material (e.g., metal). The workpiece W is made of metal (e.g., iron or copper). Therefore, if the tip end of the nozzle 52 of the laser processing head 64 comes into contact with the workpiece W, as illustrated in FIG. 8, the workpiece W, the head body 50 and the nozzle 52 of the laser processing head 64, and the conductive cable 66a form a closed circuit 70.

The resistance sensor 66b measures a resistance R of the closed circuit 70 by applying a voltage to the closed circuit 70. As illustrated in FIG. 8, when the laser processing head 64 and the workpiece W are in contact with each other, the resistance R measured by the resistance sensor 66b is an extremely small value R₀ (R₀≈0). On the other hand, when the laser processing head 64 and the workpiece W are in non-contact with each other (i.e., the tip end of the nozzle 52 is separated from the workpiece W), the resistance R measured by the resistance sensor 66b is an extremely large value R₁ (R₁≈∞>>R₀).

The contact detection device 66 can detect whether or not the laser processing head 64 and the workpiece W are in contact or in non-contact based on the resistance R measured by the resistance sensor 66b. The resistance sensor 66b supplies the processor 68 with, as detection data DD, measurement data of the resistance R having been measured, or contact determination data indicating contact or non-contact between the laser processing head 64 and the workpiece W. The processor 68 can determine whether or not the laser processing head 64 and the workpiece W are in contact or in non-contact from the detection data DD of the resistance sensor 66b. The resistance sensor 66b may be incorporated in the head body 50.

With reference to FIG. 7, the processor 68 includes a CPU or a GPU, and is incorporated in the head body 50. The processor 68 is communicably connected to the mode selection switch 48, the first input device 58, the second input device 60, the distance measuring sensor 62, and the resistance sensor 66b via a bus (or a communication line) 72.

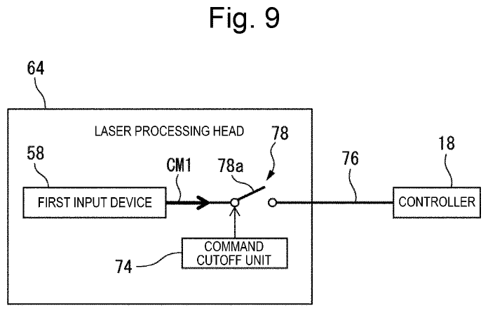

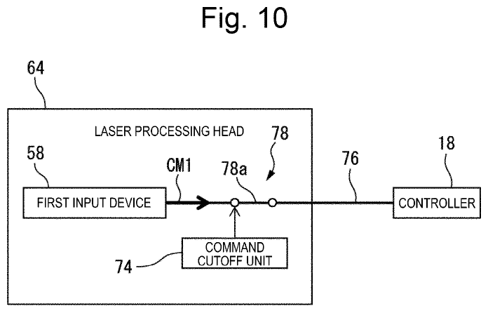

Here, in the present embodiment, the processor 68 functions as a command cutoff unit 74, and cuts off the manual laser emission command CM1 transmitted from the first input device 58 to the controller 18 when a condition CD to execute the laser emission operation LO in the manual drive mode DM1 is not satisfied. The function of the command cutoff unit 74 will be described with reference to FIGS. 9 and 10.

FIG. 9 schematically illustrates a state in which the command cutoff unit 74 cuts off the manual laser emission command CM1. Specifically, the manual laser emission command CM1 transmitted by the first input device 58 is transmitted to the controller 18 through a communication line 76, and the communication line 76 is provided with a cutoff circuit 78.

The cutoff circuit 78 includes, for example, a switch 78a (relay or the like) that can be electronically controlled and is incorporated in the head body 50 of the laser processing head 64. The command cutoff unit 74 cuts off the manual laser emission command CM1 or permits transmission of the manual laser emission command CM1 by opening/closing the switch 78a of the cutoff circuit 78 in accordance with the predetermined condition CD.

For example, the condition CD to execute the laser emission operation LO in the manual drive mode DM1 includes a first condition CD1 that the manual drive mode DM1 is selected by the mode selection switch 48 and a second condition CD2 that the laser processing head 64 is in contact with the workpiece W.

When the first condition CD1 or the second condition CD2 is not satisfied, the command cutoff unit 74 opens the switch 78a of the cutoff circuit 78 as illustrated in FIG. 9, thereby cutting off the manual laser emission command CM1. On the other hand, when the first condition CD1 and the second condition CD2 are satisfied, as illustrated in FIG. 10, the command cutoff unit 74 closes the switch 78a of the cutoff circuit 78, thereby permitting transmission of the manual laser emission command CM1.

In this way, the processor 68 functions as the command cutoff unit 74 and operates the cutoff circuit 78 to cut off the manual laser emission command CM1 or permit the transmission of the manual laser emission command CM1 in response to the condition CD. Note that the cutoff circuit 78 (switch 78a) may be configured by an analog circuit, or may be configured by a digital circuit implemented by signal processing executed by the processor 68. The cutoff circuit 78 illustrated in FIGS. 9 and 10 is an example, and may be configured by any circuit.

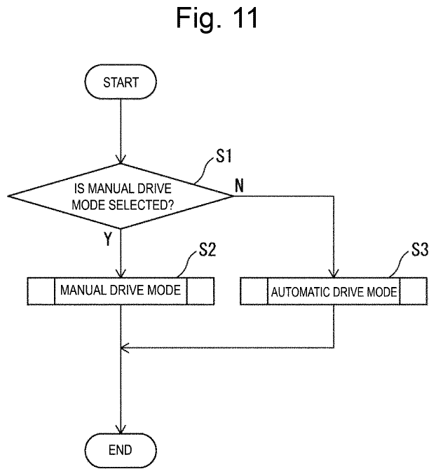

Next, the function of the laser processing head 64 will be described with reference to FIG. 11. Upon receiving an operation start command from the controller 18, the processor 68 of the laser processing head 64 starts the flow shown in FIG. 11. In step S1, the processor 68 determines whether or not the manual drive mode DM1 is selected by the mode selection switch 48. When the manual drive mode DM1 is selected by the mode selection switch 48, the processor 68 determines YES and proceeds to step S2, and when determining NO, the processor proceeds to step S3.

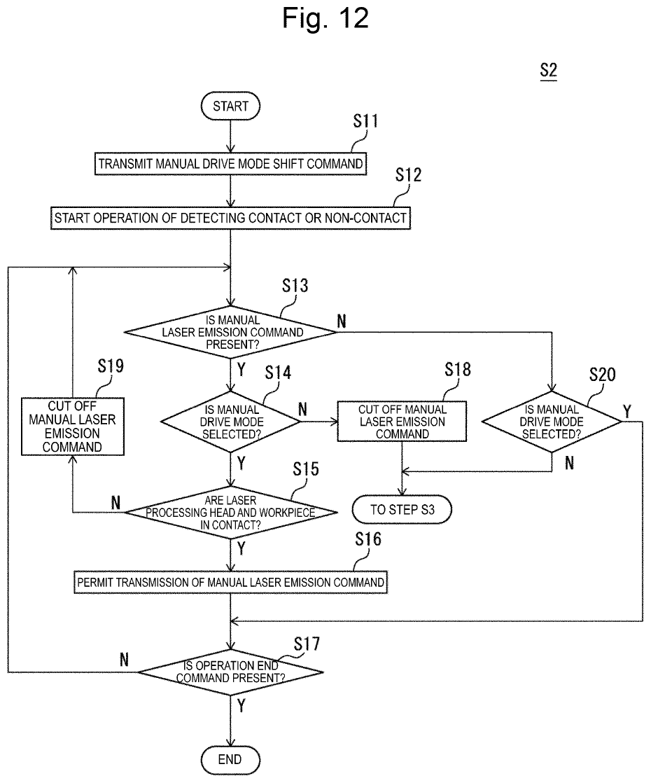

In step S2, the processor 68 executes the flow of the manual drive mode DM1. This step S2 will be described with reference to FIG. 12. At the start time point of step S2, the processor 68 may open the switch 78a of the cutoff circuit 78 as illustrated in FIG. 9, or may close the switch 78a as illustrated in FIG. 10.

After the start of step S2, the processor 68 transmits in step S11 a manual drive mode shift command CM3 to the controller 18. Upon receiving the manual drive mode shift command CM3, the processor 36 (FIG. 2) of the controller 18 shifts the drive mode DM to the manual drive mode DM1.

After the shift to the manual drive mode DM1, the processor 36 of the controller 18 is brought into a state of being capable of receiving the manual laser emission command CM1, and rejects an automatic drive start command CM4 to start the laser emission operation LO and the movement operation MO in the automatic drive mode DM2. In step S11, the mode selection switch 48 may supply the manual drive mode shift command CM3 to the controller 18. The manual drive mode shift command CM3 may be an ON signal (or “1” signal).

In step S12, the processor 68 starts an operation of detecting contact or non-contact between the laser processing head 64 and the workpiece W by the contact detection device 66. Specifically, the processor 68 causes the resistance sensor 66b to measure the resistance R, and starts an operation of continuously (e.g., periodically) acquiring the detection data DD from the resistance sensor 66b.

In step S13, the processor 68 determines whether or not the first input device 58 has received an input operation to transmit the manual laser emission command CM1. The processor 68 determines YES when the first input device 58 has received the input operation by the operator, and proceeds to step S14, and proceeds to step S20 when determining NO.

In step S14, the processor 68 determines whether or not the manual drive mode DM1 is selected by the mode selection switch 48 (i.e., the condition CD1 is satisfied), similarly to step S1 described above. When determining YES, the processor 68 proceeds to step S15, and on the other hand, when determining NO (i.e., the mode selection switch 48 is switched to the automatic drive mode DM2, and the condition CD1 is not satisfied), the processor 68 proceeds to step S18.

In step S15, the processor 68 determines whether or not the laser processing head 64 is in contact with the workpiece W (i.e., the condition CD2 is satisfied). Specifically, based on the detection data DD acquired most recently from the resistance sensor 66b, the processor 68 determines whether or not contact between the laser processing head 64 and the workpiece W has been detected by the contact detection device 66 or non-contact has been detected.

When the contact between the laser processing head 64 and the workpiece W has been detected, the processor 68 determines YES, and proceeds to step S16. On the other hand, when the non-contact between the laser processing head 64 and the workpiece W has been detected (i.e., when the condition CD2 is not satisfied), the processor determines NO, and proceeds to step S19.

In step S16, the processor 68 permits transmission of the manual laser emission command CM1 from the first input device 58 to the controller 18. Specifically, the processor 68 functions as the command cutoff unit 74, and operates the cutoff circuit 78 to close the switch 78a as illustrated in FIG. 10.

Due to this, the first input device 58 can transmit the manual laser emission command CM1 to the controller 18 through the communication line 76 in response to the input operation of the operator received in step S13. The processor 36 of the controller 18 executes the laser emission operation LO in response to the manual laser emission command CM1 from the first input device 58, and as a result, the laser beam LB is emitted from the emission port 52a of the laser processing head 64. Thus, the operator can manually perform laser process on the workpiece W.

In step S17, the processor 68 determines whether or not an operation end command is received from the controller 18. When the operation end command is received, the processor 68 determines YES, and ends the flow of step S2, thereby ending the flow shown in FIG. 11. On the other hand, when determining NO, the processor 68 returns to step S13. When determining YES in step S17, the processor 68 may function as the command cutoff unit 74 and operate the cutoff circuit 78 to open the switch 78a.

On the other hand, when determining NO in step S14, the processor 68 cuts off in step S18 the manual laser emission command CM1 transmitted from the first input device 58 to the controller 18. Specifically, the processor 68 functions as the command cutoff unit 74, and operates the cutoff circuit 78 to open the switch 78a as illustrated in FIG. 9.

Due to this, the manual laser emission command CM1 transmitted from the first input device 58 to the controller 18 is cut off, and the processor 36 of the controller 18 does not execute the laser emission operation LO. After step S18, the processor 68 of the laser processing head 64 proceeds to step S3 in FIG. 11.

On the other hand, when determining NO in step S15, the processor 68 functions in step S19 as the command cutoff unit 74, similarly to step S18 described above, and cuts off the manual laser emission command CM1 transmitted from the first input device 58 to the controller 18. Then, the processor 68 returns to step S13.

When determining NO in step S13, the processor 68 determines in step S20 whether or not the manual drive mode DM1 is selected by the mode selection switch 48 similarly to step S14 described above. The processor 68 proceeds to step S17 when determining YES, and proceeds to step S3 in FIG. 11 when determining NO.

Thus, while determining YES in steps S13 to S15 and determining NO in step S17, the processor 68 continuously permits transmission of the manual laser emission command CM1 in step S16. This enables the operator to continue manual laser process while performing an input operation on the first input device 58.

On the other hand, when determining YES in step S13 and then determining NO in step S14 or S15, the processor 68 cuts off the manual laser emission command CM1 in step S18 or S19. As a result, the laser emission operation LO in the manual drive mode DM1 is prohibited.

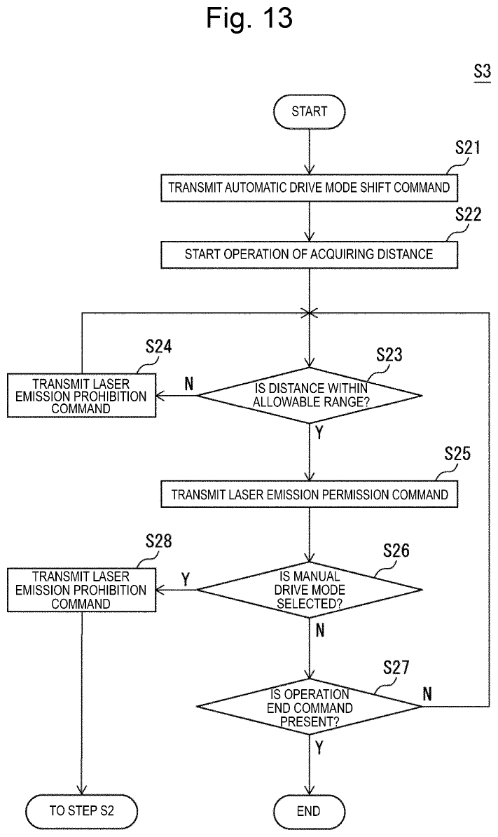

With reference to FIG. 11 again, when determining NO in step S1 (alternatively, after determining NO in step S20 in FIG. 12 or after execution of step S18), the processor 68 executes the flow of the automatic drive mode DM2 in step S3. This step S3 will be described with reference to FIG. 13. At the start time point of step S3, the processor 68 may open the switch 78a of the cutoff circuit 78 as illustrated in FIG. 9.

After start of step S3, in step S21, the processor 68 transmits an automatic drive mode shift command CM5 to the controller 18. Upon receiving the automatic drive mode shift command CM5, the processor 36 (FIG. 2) of the controller 18 shifts the drive mode DM to the automatic drive mode DM2. In step S21, the mode selection switch 48 may supply the automatic drive mode shift command CM5 to the controller 18. The automatic drive mode shift command CM5 may be an OFF signal (or “0” signal).

After the shift to the automatic drive mode DM2, the processor 36 of the controller 18 is brought into a state of being capable of receiving the automatic drive start command CM4, and rejects the manual laser emission command CM1 from the laser processing head 64. Upon receiving the automatic drive start command CM4 from the operator through the input device 44, for example, the processor 36 automatically executes the laser emission operation LO and the movement operation MO in the automatic drive mode DM2 in accordance with the machining program PG1.

In step S22, the processor 68 starts an operation of acquiring the distance d measured by the distance measuring sensor 62. Specifically, the processor 68 operates the distance measuring sensor 62 to continuously (e.g., periodically) measure the distance d between the laser processing head 64 and the workpiece W. The processor 68 continuously (e.g., periodically) acquires the distance d measured by the distance measuring sensor 62.

In step S23, the processor 68 determines whether or not the distance d acquired most recently from the distance measuring sensor 62 is within the predetermined allowable range RG. For example, the allowable range RG may be defined as a range of d≤dₜₕ (e.g., dₜₕ=3 [mm]), or may be defined as a range of [dₜₕ₁, dₜₕ₂] (e.g., dₜₕ₁=0.1 [mm], dₜₕ₂=3 [mm]) (i.e., dₜₕ₁≤d≤dₜₕ₂). When the distance d is within the allowable range RG, the processor 68 determines YES and proceeds to step S25. On the other hand, when the distance d is out of the allowable range RG, the processor 68 determines NO and proceeds to step S24.

In step S24, the processor 68 transmits a laser emission prohibition command CM6 to the controller 18. The laser emission prohibition command CM6 is a command for prohibiting the processor 36 of the controller 18 from performing the laser emission operation LO in the automatic drive mode DM2. Upon receiving the laser emission prohibition command CM6, the processor 36 of the controller 18 stops (or does not start) the laser emission operation LO in the automatic drive mode DM1.

As described above, in the present embodiment, the processor 68 of the laser processing head 64 functions as a command transmission unit 80 (FIG. 7) that transmits the laser emission prohibition command CM6 to the controller 18. The laser emission prohibition command CM6 may be an OFF signal (or “0” signal).

After step S24, the processor 68 returns to step S23. Thus, while determining NO in step S23, the processor 68 transmits the laser emission prohibition command CM6 in step S24 thereby prohibiting the controller 18 from executing the laser emission operation LO in the automatic drive mode DM2.

On the other hand, when determining YES in step S23, the processor 68 functions in step S25 as the command transmission unit 80 and transmits a laser emission permission command CM7 to the controller 18. The laser emission permission command CM7 is a command for permitting the processor 36 of the controller 18 to execute the laser emission operation LO in the automatic drive mode DM2.

Upon receiving the laser emission permission command CM7, the processor 36 of the controller 18 can execute the laser emission operation LO in the automatic drive mode DM1 in response to the automatic drive start command CM4. The laser emission permission command CM7 may be an ON signal (or “1” signal).

In step S26, the processor 68 determines whether or not the manual drive mode DM1 has been selected by the mode selection switch 48, similarly to step S14 described above. The processor 68 proceeds to step S28 when determining YES, and proceeds to step S27 when determining NO.

In step S27, the processor 68 determines whether or not an operation end command has been received, similarly to step S17 described above. When determining YES, the processor 68 ends the flow of step S3, and thus ends the flow shown in FIG. 11. On the other hand, when determining NO, the processor 68 returns to step S23.

On the other hand, when determining YES in step S26, the processor 68 transmits in step S28 the laser emission prohibition command CM6 to the controller 18, similarly to step S24 described above. Then, the processor 68 proceeds to step S2 in FIG. 11.

As described above, in the present embodiment, the laser processing head 64 further includes the command cutoff unit 74 that cuts off the manual laser emission command CM1 transmitted from the first input device 58 to the controller 18 when the condition CD (CD1 or CD2) to execute the laser emission operation LO in the manual drive mode DM1 is not satisfied (i.e., when NO is determined in step S14 or S15).

According to this configuration, when the condition CD to ensure the safety of the operator in the manual drive mode DM1 is not satisfied, it is possible to prohibit the laser beam LB from being emitted from the laser processing head 64 by cutting off the manual laser emission command CM1. This can reliably ensure the safety of the operator in the manual drive mode DM1.

In the present embodiment, the laser processing head 64 further includes the mode selection switch 48 capable of selecting the manual drive mode DM1 or the automatic drive mode DM2. The condition CD includes the first condition CD1 that the manual drive mode DM1 is selected by the mode selection switch 48.

When the manual drive mode DM1 is not selected by the mode selection switch 48 (NO is determined in step S14), the command cutoff unit 74 cuts off the manual laser emission command CM1 (step S18). According to this configuration, for the operator to perform laser process in the manual drive mode DM, work of manually switching the mode selection switch 48 to the manual drive mode DM1 is necessary. Therefore, unintentional execution of the laser emission operation LO in the manual drive mode DM can be avoided.

In the present embodiment, the laser processing head 64 further includes the contact detection device 66 that detects contact or non-contact between the laser processing head 64 and the workpiece W. The condition CD includes the second condition CD2 that the laser processing head 64 is in contact with the workpiece W. Then, when non-contact is detected by the contact detection device 66 (when NO is determined in step S15), the command cutoff unit 74 cuts off the manual laser emission command CM1 (step S19).

According to this configuration, when the laser emission operation LO is executed in the manual drive mode DM, the laser processing head 64 is separated from the workpiece W, and the laser beam LB from the laser processing head 64 can be prevented from being emitted in an unintended direction (e.g., the direction of the operator). This can ensure more reliably the safety of the operator in the manual drive mode DM1.

In the present embodiment, the contact detection device 66 includes the conductive cable 66a that electrically connects the laser processing head 64 and the workpiece W, and the resistance sensor 66b that measures the resistance R of the workpiece W, the laser processing head 64 in contact with the workpiece W, and the closed circuit 70 formed by the conductive cable 66a.

Thus, the contact detection device 66 is configured to detect contact or non-contact between the laser processing head 64 and the workpiece W based on the resistance R measured by the resistance sensor 66b. According to this configuration, contact or non-contact between laser processing head 64 and workpiece W can be quickly and reliably detected with a relatively simple configuration.

In the present embodiment, the laser processing head 64 further includes the command transmission unit 80 that transmits, to the controller 18, the laser emission prohibition command CM6 to cause the controller 18 to prohibit the laser emission operation LO in the automatic drive mode DM2 when the distance d measured by the distance measuring sensor 62 is out of the predetermined allowable range RG (i.e., when NO is determined in step S23).

According to this configuration, when the workpiece W is not disposed at an appropriate position with respect to the laser processing head 64 at the time of executing the laser emission operation LO in the automatic drive mode DM2, the laser emission operation LO can be prohibited. This can enhance the safety of the laser process work executed in the automatic drive mode DM2.

The mode selection switch 48 may be omitted from the laser processing head 64, and the mode selection switch 48 may be provided at the controller 18 as in the embodiment illustrated in FIG. 1. The contact detection device 66 may be omitted from the laser processing head 64. In this case, steps S15 and S19 can be omitted from the flow shown in FIG. 12. Note that the contact detection device 66 is not limited to the form including the conductive cable 66a and the resistance sensor 66b, and may include any sensor such as a proximity sensor capable of detecting contact between the laser processing head 64 and the workpiece W, for example.

The command transmission unit 80 may be omitted from the laser processing head 64. In this case, the processor 68 (alternatively, the distance measuring sensor 62) of the laser processing head 64 may supply measurement data of the distance d measured by the distance measuring sensor 62 to the controller 18. Then, the processor 36 of the controller 18 may determine whether or not the laser emission operation LO can be executed in the automatic drive mode DM2 based on the measurement data.

The processor 36 of the controller 18 may continuously (e.g., periodically) acquire the measurement data of the distance d from the distance measuring sensor 62 while executing the laser emission operation LO and the movement operation MO in the automatic drive mode DM2. Then, based on the measurement data having been acquired, the processor 36 may execute gap control to control the distance d between the laser processing head 14 and the workpiece W to a predetermined target distance do. The target distance do can be determined in advance as a value within the above-described allowable range RG.

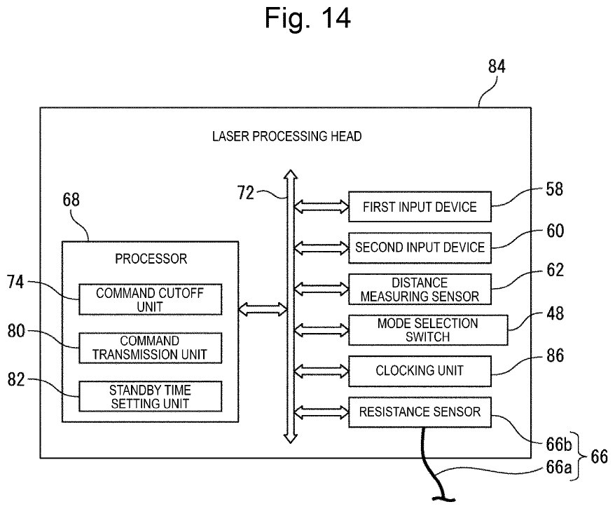

Next, a laser processing head 84 according to still another embodiment will be described with reference to FIG. 14. The laser processing head 84 is applicable to the laser processing system 10 in place of the laser processing head 64 described above. The laser processing head 84 is different in further including the laser processing head 64 described above and a clocking unit 86. The clocking unit 86 is incorporated in the head body 50 together with, for example, the processor 68 and the resistance sensor 66b, and clocks the elapsed time t from a certain time point.

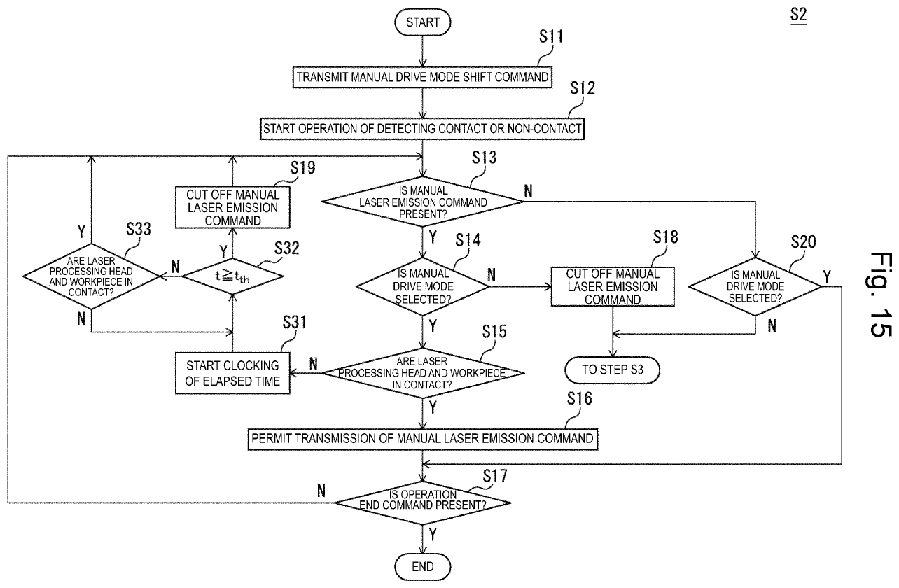

Next, step S2 executed by the laser processing head 84 will be described with reference to FIG. 15. The processor 68 of the laser processing head 84 executes the flow shown in FIG. 15 as step S2 in FIG. 11. Note that in the flow shown in FIG. 15, processes similar to those in the flow shown in FIG. 12 are denoted by the same step numbers, and redundant description is omitted.

Here, in the present embodiment, the processor 68 sets in advance a standby time tₜₕ from a time point t₀ when non-contact between the laser processing head 84 and the workpiece W is detected by the contact detection device 66 (i.e., NO is determined in step S15) to when the manual laser emission command CM1 is cut off in step S19.

For example, the operator operates the input device 44 of the controller 18 to input the standby time tₜₕ (e.g., tₜₕ=0.4 [sec]). The processor 68 obtains the standby time tₜₕ from the controller 18, and registers setting information of the standby time tₜₕ in a register incorporated in the processor 68, for example.

Note that the laser processing head 84 may further include a memory (ROM, RAM, or the like), and the processor 68 may register setting information of the standby time tₜₕ into the memory. In this way, the processor 68 sets the standby time tₜₕ in advance. Therefore, the processor 68 functions as a standby time setting unit 82 (FIG. 14) that sets the standby time tₜₕ.

In step S2 shown in FIG. 15, when determining NO in step S15, the processor 68 starts clocking of the elapsed time t in step S31. Specifically, the processor 68 activates the clocking unit 86 to start clocking of the elapsed time t from a time point t₀ at which NO is determined in step S15.

In step S32, the processor 68 determines whether or not the elapsed time t clocked by the clocking unit 86 has reached a standby time tₜₕ set in advance (i.e., t≥tₜₕ). When t≥tₜₕ, the processor determines YES and proceeds to step S19. On the other hand, when t<tₜₕ, the processor 68 determines NO and proceeds to step S33.

In step S33, the processor 68 determines whether or not contact between the laser processing head 84 and the workpiece W has been detected by the contact detection device 66, similarly to step S15 described above. The processor 68 returns to step S13 when determining YES, on the other hand, returns to step S32 when determining NO (i.e., when the laser processing head 84 and the workpiece W are still in non-contact with each other).

Technical significance of steps S31 to S33 will be described below. Once the processor 68 permits transmission of the manual laser emission command CM1 in step S16, the processor 36 of the controller 18 executes the laser emission operation LO in the manual drive mode DM1. When NO is determined in step S15 during the execution of the laser emission operation LO (i.e., while the determination of YES is continued in step S13), the processor 68 does not execute step S19 until the standby time tₜₕ elapses from the time point t₀ at which NO is determined in step S15 (i.e., until YES is determined in step S32) (in other words, the laser emission operation LO is continued).

Then, when continuously determining NO in step S33 before the standby time tₜₕ elapses (i.e., when non-contact between the laser processing head 84 and the workpiece W is continuously detected over the period tₜₕ), the processor 68 executes step S19 as the command cutoff unit 74, and as a result, prohibits the laser emission operation LO.

As described above, in the present embodiment, the laser processing head 84 further includes the standby time setting unit 82 that sets the standby time tₜₕ from the time point t₀ at which the non-contact is detected by the contact detection device 66 when the controller 18 executes the laser emission operation LO in the manual drive mode DM1 (determined to be NO in step S15) to when the command cutoff unit 74 cuts off the manual laser emission command CM1 (i.e., step S19 is executed).

Then, when the standby time tₜₕ set by the standby time setting unit 82 elapses from the time point to (determined to be YES in step S32), the command cutoff unit 74 cuts off the manual laser emission command CM1 (step S19). Here, in the manual drive mode DM1, the operator may execute the laser process with the laser beam LB emitted from the laser processing head 84 while moving the laser processing head 84 to the workpiece W while bringing the tip end of the laser processing head 84 into contact with the workpiece W.

In this case, the laser processing head 84 can be instantaneously (e.g., only 0.3 [sec]) separated from the workpiece W by an uneven part on the surface of the workpiece W, for example. Even if the laser processing head 84 is instantaneously separated from the workpiece W in this manner, there is a low possibility that the laser beam LB from the laser processing head 84 is emitted in the direction of the operator, and hence the safety of the operator can be secured.

According to the present embodiment, by setting the standby time tₜₕ until the manual laser emission command CM1 is cut off in step S19, the laser emission operation LO can be continued even if the above-described instantaneous separation of the laser processing head 84 from the workpiece W occurs. On the other hand, when non-contact between the laser processing head 84 and the workpiece W is still detected even after the standby time tₜₕ has elapsed, the laser emission operation LO can be prohibited by immediately executing step S19. Therefore, according to the present embodiment, work of laser processing can be efficiently performed, and the safety of the operator can be reliably ensured.

Note that the processor 68 may execute the flow shown in FIG. 11 in accordance with a computer program PG2. The computer program PG2 may be stored in a memory (ROM, RAM, and the like) incorporated in the laser processing head 14, 64, or 84. The functions of the command cutoff unit 74, the command transmission unit 80, and the standby time setting unit 82 executed by the processor 68 may be functional modules achieved by the computer program PG2.

Note that the first input device 58′ illustrated in FIG. 5 may be applied to the laser processing head 64 or 84. The processor 68 may execute the flow shown in FIG. 11 and control the above-described lens drive unit. The clocking unit 86 may be omitted from the laser processing head 84. In this case, the clocking unit 86 may be provided at the controller 18, and the processor 68 may acquire the information of the elapsed time t from the clocking unit 86 of the controller 18. The light guide path 34 may be omitted from the laser processing system 10. In this case, the laser oscillator 16 may be directly coupled to the laser processing head 14, 14′, 64, or 84.

Note that the laser processing head 14, 14′, 64, or 84 may be any type of device, for example, a laser scanner (alternatively, a galvanometer scanner). The laser scanner includes a plurality of mirrors that each reflect the laser beam LB supplied from the laser oscillator 16, a plurality of mirror drive units that individually drive the plurality of mirrors, and an optical lens that collects the laser beams reflected by the mirrors. By changing the directions of the plurality of mirrors by the mirror drive unit, the laser scanner can move, at a high speed on the surface of the workpiece W, an irradiation point of the laser beam LB with which the workpiece W is irradiated.

The robot 12 is not limited to the vertical articulated robot, and may be, for example, a horizontal articulated robot or a parallel link robot, and may be configured to include first and second ball screw mechanisms that moves the workpiece W in a horizontal plane, and a third ball screw mechanism that moves the laser processing head 14, 14′, 64, or 84 in the vertical direction.

The controller 18 may include a first controller 18A that controls the movement operation MO of the robot 12 and a second controller 18B that controls the laser emission operation LO of the laser oscillator 16. While the present disclosure has been described through the embodiments above, the embodiments described above do not limit the scope of the invention claimed in the claims.

### REFERENCE SIGNS LIST

10 Laser processing system
12 Robot
14, 14′, 64, 84 Laser processing head
16 Laser oscillator
18 Controller
36, 68 Processor
48 Mode selection switch
54 Attachment tool
56 Grip
58, 58′ First input device
60 Second input device
62 Distance measuring sensor
66 Contact detection device
70 Closed circuit
74 Command cutoff unit
80 Command transmission unit
82 Standby time setting unit

1. A laser processing head capable of performing a laser emission operation in a manual drive mode, in which a controller executes a laser emission operation in accordance with a manual laser emission command, and an automatic drive mode, in which the controller automatically executes a laser emission operation in accordance with a machining program, the laser processing head comprising:
a first input device configured to receive an input operation to transmit the manual laser emission command to the controller; and
a distance measuring sensor configured to measure a distance between the laser processing head and a workpiece when the controller executes the laser emission operation in the automatic drive mode.

2. The laser processing head of claim 1, wherein the first input device includes:
a press button, a switch, or a touchscreen to which an operator can perform an input operation with a hand, or
a foot pedal or a foot switch to which an operator can perform an input operation with a foot.

3. The laser processing head of claim 1, further comprising a second input device configured to receive an input operation to transmit a manual gas emission command for emitting an assist gas.

4. The laser processing head of claim 1, further comprising a command cutoff unit configured to cut off the manual laser emission command to be transmitted from the first input device to the controller when a condition for executing the laser emission operation in the manual drive mode is not satisfied.

5. The laser processing head of claim 4, further comprising a mode selection switch by which the manual drive mode or the automatic drive mode can be selected,
wherein the condition includes a first condition that the manual drive mode is selected by the mode selection switch, and
wherein the command cutoff unit is configured to cut off the manual laser emission command when the manual drive mode is not selected by the mode selection switch.

6. The laser processing head of claim 4, further comprising a contact detection device configured to detect contact or non-contact between the laser processing head and the workpiece,
wherein the condition includes a second condition that the laser processing head is in contact with the workpiece, and
wherein the command cutoff unit is configured to cut off the manual laser emission command when the non-contact is detected by the contact detection device.

7. The laser processing head of claim 6, wherein the contact detection device includes:
a conductive cable electrically connecting the laser processing head and the workpiece; and
a resistance sensor configured to measure resistance of a closed circuit formed by the workpiece, the laser processing head in contact with the workpiece, and the conductive cable,
wherein the contact detection device is configured to detect the contact or the non-contact based on the resistance measured by the resistance sensor.

8. The laser processing head of claim 6, further comprising a standby time setting unit configured to set a standby time from a time point at which the non-contact is detected by the contact detection device when the controller executes the laser emission operation in the manual drive mode to when the command cutoff unit is to cut off the manual laser emission command, wherein the command cutoff unit is configured to cut off the manual laser emission command when the standby time set by the standby time setting unit elapses from the time point.

9. The laser processing head of claim 1, further comprising a command transmission unit configured to transmit to the controller a laser emission prohibition command for prohibiting the controller from performing the laser emission operation in the automatic drive mode when the distance measured by the distance measuring sensor is out of a predetermined allowable range.

10. The laser processing head of claim 1, further comprising:
an attachment tool detachably attached to a robot configured to move the laser processing head; and
a grip grippable by an operator with one hand,
wherein the first input device is provided adjacent to the grip such that the one hand gripping the grip can perform the input operation.

11. A laser processing system comprising:
a robot;
the laser processing head of claim 1, laser processing head detachably attached to the robot; and
the controller configured to execute the laser emission operation in the manual drive mode and the laser emission operation in the automatic drive mode.
